(19) United States
(12) Patent Application Publication
(10) Pub. No.: US 2018/0354729 A1
(43) Pub. Date: Dec. 13, 2018

(54) PIPE LOADING AND UNLOADING STATION

(71) Applicant: Advanced Drainage Systems, Inc., Hilliard, OH (US)

(72) Inventors: Nicholas James Piazza, Findlay, OH (US); Ben Fleming, Liberty Township, OH (US); Randy Kolbet, Liberty Township, OH (US); Owen Michael Atchison, Van Buren, OH (US); Eric Nye, Rawson, OH (US); Pat Scharf, Marion, OH (US)

(73) Assignee: Advanced Drainage Systems, Inc.

(21) Appl. No.: 15/616,258

(22) Filed: Jun. 7, 2017

(51) Int. Cl. B65G 47/88

(52) U.S. Cl. CPC B65G 47/8884

(57) ABSTRACT

The disclosure relates generally to pipe preparation and processing, more particularly, to a loading and unloading station for moving pipes through the preparation and processing stages of production. The pipe loading and unloading station may include an upstream ramp including a plurality of movable pipe separator tabs, a downstream ramp including a plurality of movable backstop tabs, and a conveyor located between the upstream ramp and downstream ramp and including a plurality of movable ejectors.

### FIELD OF THE DISCLOSURE

The present disclosure relates generally to pipe preparation and processing and particularly to a loading and unloading station for moving pipes through the preparation and processing stages of production.

### BACKGROUND OF THE DISCLOSURE

Pipes are commonly used in stormwater drainage, water transportation, and wastewater management applications. Pipes for these applications come in a range of lengths, diameters, and thicknesses. Pipes can be made from a variety of materials, including steel, aluminum, concrete, or plastic. Depending on the choice of material and size of the pipe, these pipes can be very heavy. A single pipe may need to go through a variety of preparation, processing, treatment, and finishing processes. However, because of a pipe's heavy weight and large size, it can be difficult to move and transport a pipe throughout the manufacturing process. In particular, it may be difficult to load pipes onto and unload pipes from the various pieces of equipment used in the manufacturing process. Moreover, as the pipes move through and between manufacturing processes, they may roll. Due to their heavy weight and unwieldy shape, the pipes may begin to travel too fast and can become difficult to control. If traveling too fast and/or out of control, the pipes may cause damage to the other pipes in the process or may damage the manufacturing machinery itself. Accordingly, there is a need for improvements in devices, systems, and methods for loading, handling, and unloading heavy pipes that address one or more of these problems.

### SUMMARY OF THE DISCLOSURE

In an aspect of the disclosure, a pipe loading and unloading station may comprise an upstream ramp including a plurality of movable pipe separator tabs, a downstream ramp including a plurality of movable backstop tabs, and a conveyor located between the upstream ramp and downstream ramp and including a plurality of movable ejectors.

In another aspect of the disclosure, a system for loading and unloading pipes may comprise an upstream ramp including a pipe loading location configured to receive a first pipe. The system may include a plurality of pipe separator tabs on the upstream ramp configured to actuate between an open position and a pipe blocking position to control the advancement of the first pipe down the upstream ramp. The system may also include a conveyor located at the bottom end of the upstream ramp configured to receive the first pipe. The system may include a plurality of backstop tabs configured to actuate between an open position and a pipe blocking position and control the advancement of the first pipe past the conveyor and to a downstream ramp. The system may also include a plurality of ejectors configured to actuate between an open position and a pipe ejecting position and eject the first pipe from the conveyor and cause the first pipe to advance down the downstream ramp. The system may also have a pipe unloading bumper configured to stop the first pipe at the bottom end of the downstream ramp.

In another aspect of the disclosure, a method of loading and unloading pipes may include actuating a plurality of rows of pipe separator tabs into a pipe blocking position. The method may next include loading a pipe onto a pipe loading location of an upstream ramp. The method may next include actuating an upper row of pipe separator tabs into an open position to allow the pipe to roll down the upstream ramp past the upper row of pipe separator tabs, then subsequently actuating a middle row of pipe separator tabs into an open position to allow the pipe to roll down the upstream ramp past the middle row of pipe separator tabs. The method may next include actuating a row of backstop tabs into a pipe blocking position, then actuating a lower row of pipe separator tabs into an open position to allow the pipe to roll down the upstream ramp past the lower row of pipe separator tabs and onto the conveyor. The method may next include actuating the row of backstop tabs into an open position. The method may next include conveying the pipe in a direction perpendicular to the direction that the pipe rolls down the upstream ramp and then conveying the pipe back to a position aligned with the downstream ramp. The method may next include actuating a row of ejectors to contact the pipe and eject the pipe from the conveyor and cause the pipe to roll down the downstream ramp.

In yet another aspect of the disclosure, a method of loading and unloading pipes may include actuating a row of ejectors to contact and eject a first pipe from a conveyor, causing the first pipe to roll down a downstream ramp. The method may next include actuating a row of backstop tabs into a pipe blocking position, then subsequently actuating a lower row of pipe separator tabs into an open position to allow a second pipe to roll down an upstream ramp past the lower row of pipe separator tabs and onto the conveyor. The method may next include actuating the row of backstop tabs into an open position, then subsequently actuating the lower row of pipe separator tabs into a pipe blocking position. The method may next include actuating a middle row of pipe separator tabs into an open position to allow a third pipe to roll down the upstream ramp past the middle row of pipe separator tabs. The method may next include actuating the middle row of pipe separator tabs into a pipe blocking position, then subsequently actuating an upper row of pipe separator tabs into an open position to allow a fourth pipe to roll down the upstream ramp.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a perspective view of an exemplary pipe loading and unloading station according to an exemplary disclosed embodiment.

FIG. 2 is a top plan view of the pipe loading and unloading station of FIG. 1 according to an exemplary disclosed embodiment.

FIG. 3 is a left side elevation view of the pipe loading and unloading station of FIG. 1 according to an exemplary disclosed embodiment.

FIG. 4 is a front elevation view of the pipe loading and unloading station of FIG. 1 according to an exemplary disclosed embodiment.

FIG. 5A is a flow chart illustrating a method of loading and unloading a pipe according to an exemplary disclosed embodiment.

FIG. 5B is a flow chart illustrating a method of loading and unloading a plurality of pipes according to an exemplary disclosed embodiment.

FIG. 6A is a flow chart illustrating a method of loading and unloading a plurality of pipes according to an exemplary disclosed embodiment.

FIG. 6B is a flow chart illustrating a method of loading and unloading a plurality of pipes according to an exemplary disclosed embodiment.

### DETAILED DESCRIPTION

Reference will now be made in detail to the exemplary embodiments of the present disclosure described above and illustrated in the accompanying drawings.

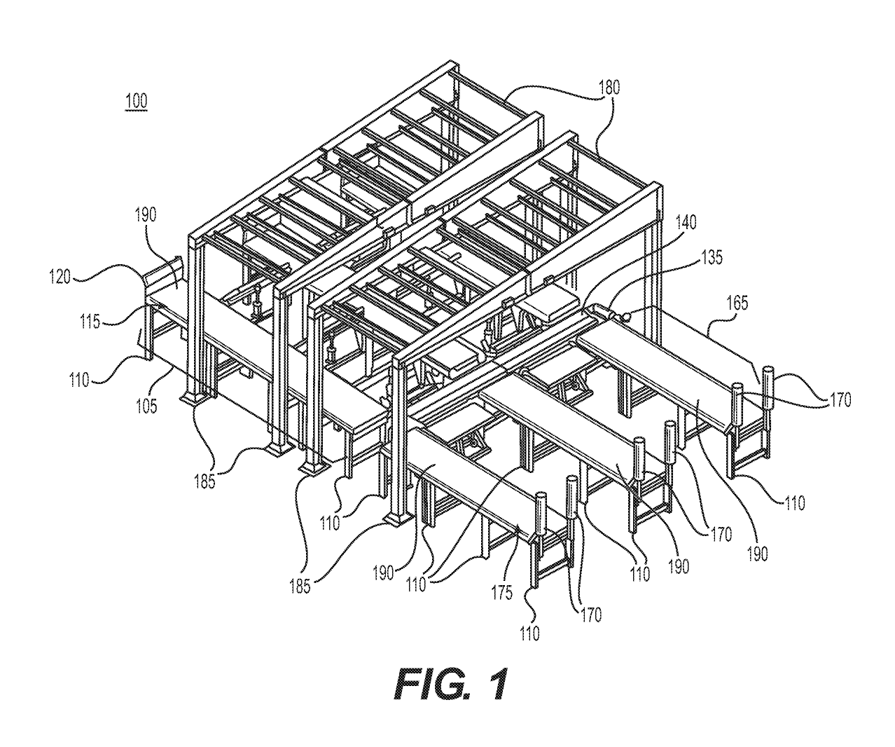

FIG. 1 illustrates a perspective view of an exemplary pipe loading and unloading station 100. Pipe loading and unloading station 100 may include an upstream ramp 105, a conveyor 135, and a downstream ramp 165. Upstream ramp 105 may be positioned upstream of conveyor 135. Downstream ramp 165 may be positioned downstream of conveyor 135. Upstream ramp 105 and downstream ramp 165 may be supported by legs 110. Legs 110 may be different heights such that upstream ramp 105 and downstream ramp 165 may be slanted. Upstream ramp 105 and downstream ramp 165 may be slanted at a downward angle from a top end to a bottom end to promote pipes to advance in a downstream direction. Pipes may advance in a downstream direction by rolling, sliding, or slipping. As an example, upstream ramp 105 and downstream ramp 165 may be slanted at an angle of less than 10 degrees. As another example, upstream ramp 105 and downstream ramp 165 may be slanted at an angle of less than 5 degrees. It should be appreciated, however, that in other embodiments, the angle may vary depending on the size and weight of the pipes. The angle of upstream ramp 105 and downstream ramp 165 may be selected to cause pipes to advance downstream at an appropriate speed to maintain control and prevent damage to the pipes and to the components of pipe loading and unloading station 100. Upstream ramp 105 and downstream ramp 165 may comprise a number of individual ramp pieces 190 separated by gaps. In some embodiments, upstream ramp 105 and downstream ramp 165 may comprise three individual ramp pieces 190 separated by two gaps. In other embodiments, upstream ramp 105 and downstream ramp 165 may comprise two individual ramp pieces 190 separated by one gap. In some embodiments, individual ramp pieces 190 of upstream ramp 105 and downstream ramp 165 may be made of expanded metal. The expanded metal may be covered in rubber, plastic, or powder. In other embodiments, individual ramp pieces 190 of upstream ramp 105 and downstream ramp 165 may be made of sheet metal, which may be covered in rubber, plastic, or powder. In still other embodiments, individual ramp pieces 190 of upstream ramp 105 and downstream ramp 165 may be made of galvanized tread plate, which may be covered in rubber, plastic, or powder.

As explained in more detail below, pipe loading and unloading station 100 may include a pipe loading location 115 and pipe loading bumpers 120 positioned at the top end of upstream ramp 105. Pipe loading and unloading station 100 may also include pipe unloading location 175 and pipe unloading bumpers 170 located at the bottom end of downstream ramp 165. Conveyor 135 may have a concave surface 140. Pipe loading and unloading station 100 may also include canopies 180 positioned above upstream ramp 105, conveyor 135, or downstream ramp 165 and supported by canopy legs 185.

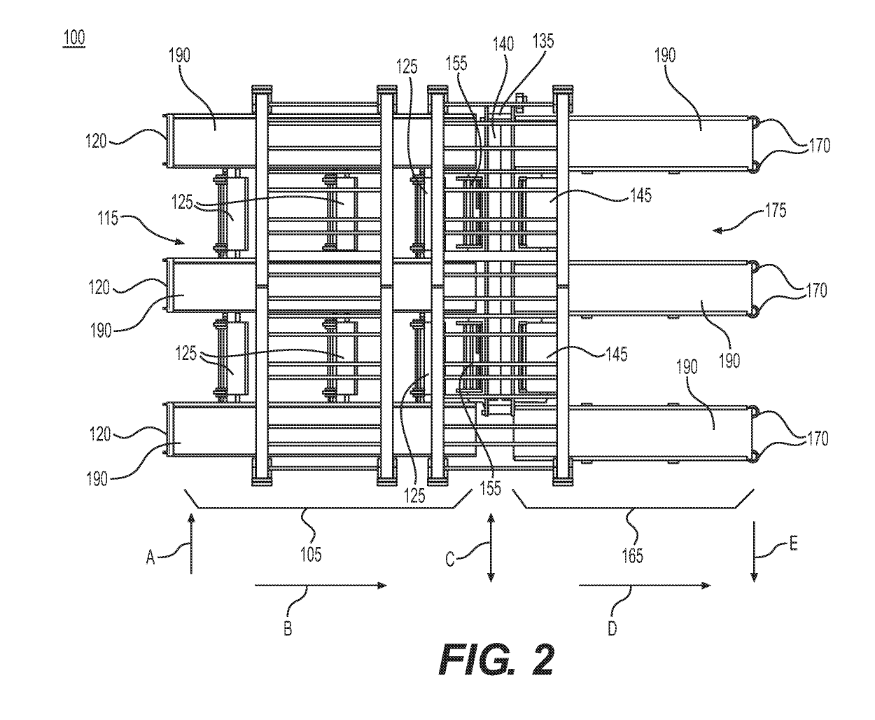

FIG. 2 illustrates a top plan view of pipe loading and unloading station 100. Upstream ramp 105 may include a pipe loading location 115. In some embodiments, pipe loading location 115 may be configured to accept one pipe at a time. In some embodiments, a user may manually or mechanically load a pipe onto pipe loading location 115. In other embodiments, a pipe may be automatically loaded onto pipe loading location 115 from another sub-system in a pipe preparation or processing system. Upstream ramp 105 may include pipe loading bumpers 120. Pipe loading bumpers 120 may be positioned at the top end of upstream ramp 105. Pipe loading bumpers 120 may be configured to prevent pipes from falling off of upstream ramp 105. Upstream ramp 105 may be downwardly slanted from a top end where pipe loading location 115 and pipe loading bumper 120 are located to a bottom end where conveyor 135 is located. In other words, the top end of upstream ramp 105 may be at a height greater than the bottom end of upstream ramp 105. As explained in more detail below, upstream ramp 105 may include a plurality of movable pipe separator tabs 125, conveyor 135 may include one or more movable ejectors 155, and downstream ramp 165 may include a plurality of movable backstop tabs 145.

The direction that pipes may travel throughout pipe loading and unloading station 100 is shown in FIG. 2. Pipes may be loaded onto pipe loading location 115 in the direction of arrow A. As mentioned above, pipes may advance along upstream ramp 105 in a downstream direction, indicated by arrow B. Similarly, pipes may advance along downstream ramp 165 in a downstream direction, indicated by arrow D. As described in more detail below, conveyor 135, with concave surface 140, may convey a pipe in a direction perpendicular (indicated by arrow C) to the direction that a pipe travels down upstream ramp 105 and downstream ramp 165. As will be explained in more detail below, downstream ramp 165 may include a pipe unloading location 175 and pipe unloading bumpers 170. Pipes may be unloaded from pipe unloading location 175 in the direction of arrow E.

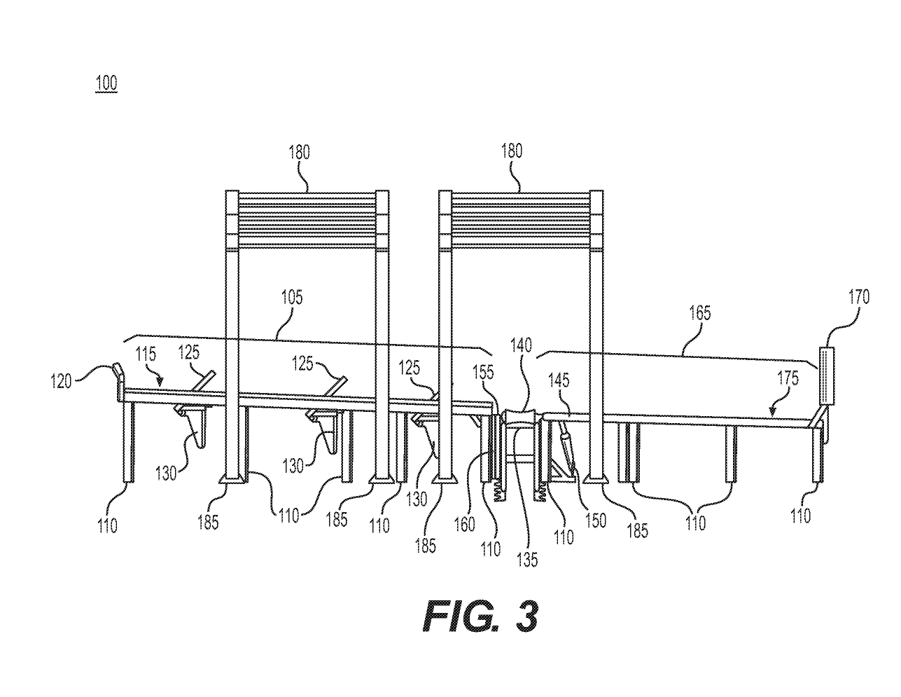

FIG. 3 illustrates a left side elevation view of pipe loading and unloading station 100. Upstream ramp 105 may include a plurality of movable pipe separator tabs 125. The plurality of pipe separator tabs 125 may be located in the gaps between individual ramp pieces 190 (shown in FIG. 2) of upstream ramp 105. Pipe separator tabs 125 may be arranged in one or more rows. In some embodiments, pipe separator tabs 125 may be arranged in three rows (an upper row, a middle row, and a lower row) and positioned along the length of upstream ramp 105. In other embodiments, there may be a plurality of upper rows and a plurality of lower rows. Rows of pipe separator tabs 125 may be spaced so that only one pipe may fit between rows of pipe separator tabs 125. Allowing only one pipe between rows of pipe separator tabs 125 prevents the weight of multiple pipes from causing the pipes to advance down upstream ramp 105 too fast. Allowing only one pipe between rows of pipe separator tabs 125 also prevents the weight of multiple pipes from overpowering or damaging pipe separator tabs 125. Pipe separator tabs 125 may be movable between a pipe blocking position and an open position. For example, pipe separator tabs 125 may move between the pipe blocking position and open position by pivoting, rotating, sliding, or rising. Pipe separator tabs 125 may be positioned at least far enough apart so that they do not interfere or overlap with one another when moving between the pipe blocking position and open position. As illustrated in FIG. 3, when in the pipe blocking position, pipe separator tabs 125 may be in an upper position extending above the surface of upstream ramp 105 to prevent the advancement of a pipe along upstream ramp 105. When pipe separator tabs 125 are in the pipe blocking position, a pipe advancing down upstream ramp 105 may contact and come to rest against pipe separator tabs 125. When in the open position, pipe separator tabs 125 may be in a lower position below the surface of the upstream ramp 105 to allow the advancement of a pipe along upstream ramp 105. When pipe separator tabs 125 are in the open position, a pipe advancing down upstream ramp 105 would not contact pipe separator tabs 125 and would continue to advance along upstream ramp 105.

Pipe separator tabs 125 may be movable between the pipe blocking position and open position by a plurality of pipe separator tab actuators 130. Each pipe separator tab 125 may have an associated pipe separator tab actuator 130. In some embodiments, pipe separator tab actuators 130 may be hydraulic or pneumatic pistons. Pipe separator tab actuators 130 may be controlled by a controller (not illustrated). In some embodiments, the controller may control each pipe separator tab actuator 130 independently. In other embodiments, the controller may control pipe separator tab actuators 130 in a single row collectively. The controller may be user-operated or automated. For example, an automated controller may control an individual pipe separator tab actuator 130 or a row of pipe separator tab actuators 130 at regular time intervals. As another example, an automated controller may control an individual pipe separator tab actuator 130 or a row of pipe separator tab actuators 130 when a sensor senses that a pipe is resting against pipe separator tabs 125. For example, in one embodiment, each pipe separator tab 125 may contain a light, motion, or pressure sensor. In that embodiment, when the sensors determine that a pipe is resting against all of the pipe separator tabs 125 in a row, the controller may actuate the pipe separator tab actuators 130 of that row. As another exemplary embodiment, only a single pipe separator tab 125 per row may contain a light, motion, or pressure sensor. In that embodiment, when the sensor determines that a pipe is resting against the pipe separator tab 125, the controller may actuate the pipe separator tab actuators 130 of that row. In another embodiment, each pipe separator tab actuator 130 may have a proximity sensor to monitor the position of each pipe separator tab actuator 130. In that embodiment, the pipe separator tab actuators 130 may be adjusted in a sequence, explained below.

Pipe loading and unloading station 100 may also include a conveyor 135. As mentioned above, conveyor 135 may be located downstream of upstream ramp 105 and upstream of downstream ramp 165. Conveyor 135 may be positioned at a height lower than the height of the bottom end of upstream ramp 105 and at a height higher than the height of the top end of downstream ramp 165. A pipe that has advanced to the bottom end of upstream ramp 105 may advance onto conveyor 135. In some embodiments, conveyor 135 has a concave surface 140 to cradle a pipe. The concave surface 140 of conveyor 135 may prevent a pipe from advancing onto downstream ramp 165. In some embodiments, conveyor 135 may include a conveyor belt. In other embodiments conveyor 135 may include wheels. Conveyor 135 may convey a pipe in a direction perpendicular to the direction that a pipe travels down upstream ramp 105 and downstream ramp 165. Conveyor 135 may convey a pipe to another location for processing. As examples, a pipe may be conveyed to another location to be pretreated, heated, cooled, scuffed, stripped, painted, or dried. Conveyor 135 may convey a pipe from the other location back into alignment with upstream ramp 105 and downstream ramp 165. In some embodiments, conveyor 135 may convey a pipe perpendicularly away from upstream ramp 105 and downstream ramp 165 and convey the same pipe back into alignment with upstream ramp 105 and downstream ramp 165. In other embodiments, conveyor 135 may convey a pipe perpendicularly away from upstream ramp 105 and downstream ramp 165 and convey a different pipe back into alignment with upstream ramp 105 and downstream ramp 165. Conveyor 135 may also include a laser sensor to determine the location of a pipe on conveyor 135. The laser sensor can sense where along conveyor 135 a pipe is located. For example, in some embodiments, when a processed pipe is conveyed back into alignment with upstream ramp 105 and downstream ramp 165, the laser sensor is “tripped,” causing conveyor 135 to stop with the pipe in alignment with upstream ramp 105 and downstream ramp 165.

Conveyor 135 may also include one or more movable ejectors 155. Ejectors 155 may be positioned on the upstream side of conveyor 135. Ejectors 155 may be arranged in a row. In some embodiments, ejectors 155 may be aligned with the gaps between individual ramp pieces 190 of upstream ramp 105. Ejectors 155 may be movable between an open position and an ejecting position. For example, ejectors 155 may move between the open position and the ejecting position by pivoting, rotating, sliding, or raising. When in the open position as illustrated in FIG. 3, ejectors 155 may be in a lower position below the surface of conveyor 135 to allow the advancement of a pipe off of upstream ramp 105 and onto conveyor 135. When in the ejecting position, ejectors 155 may be in an upper position extending above the surface of conveyor 135. If a pipe is resting on conveyor 135 when ejectors 155 are moved into the ejecting position, the ejectors will contact the pipe and cause the pipe to roll off of conveyor 135 and onto downstream ramp 165. Ejectors 155 may be movable between the open position and ejecting position by a plurality of ejector actuators 160. Each ejector 155 may have an associated ejector actuator 160. In some embodiments, ejector actuators 160 may be hydraulic or pneumatic pistons. In other embodiments, ejector actuators 160 may be air slides, rotary air actuators, or electric actuators. Ejector actuators 160 are controlled by a controller (not illustrated). The controller may control each ejector actuator 160 independently or as a single row collectively. The controller may be user-operated or automated. For example, an automated controller may control ejector actuators 160 at regular time intervals. As another example, an automated controller may control ejector actuators 160 when a sensor senses that a pipe has returned on conveyor 135 and is ready to be transferred from conveyor 135 to downstream ramp 165. For example, a light, motion, or pressure sensor may be configured to determine when a pipe has returned on conveyor 135 and is in alignment with downstream ramp 165. In one embodiment, a laser is used to determine when a pipe returning from processing on conveyor 135 reaches alignment with upstream ramp 105 and downstream ramp 165. When the sensor determines that a pipe has returned on conveyor 135 and is in alignment with upstream ramp 105 and downstream ramp 165, the controller may actuate the ejector actuators 160 so that ejectors 155 may contact the pipe and cause the pipe to roll off of conveyor 135 and onto downstream ramp 165.

As shown in FIG. 3, downstream ramp 165 may be positioned downstream of conveyor 135 and at a height lower than conveyor 135. Downstream ramp 165 may be downwardly slanted from a top end near where conveyor 135 is located to a bottom end. In other words, the top end of downstream ramp 165 may be at a height greater than the bottom end of downstream ramp 165. The top end of downstream ramp 165 may include a plurality of backstop tabs 145. Backstop tabs 145 may prevent a pipe from rolling off conveyor 135. As explained above, downstream ramp 165 may include a plurality of individual ramp pieces 190 separated by gaps. The plurality of backstop tabs 145 may be located in the gaps between individual ramp pieces 190 of downstream ramp 165. Backstop tabs 145 may be arranged in a row.

Backstop tabs 145 may be movable between a pipe blocking position and an open position. For example, backstop tabs 145 may move between the pipe blocking position and open position by pivoting, rotating, sliding, or raising. When in the pipe blocking position, backstop tabs 145 may be in an upper position extending above the surface of downstream ramp 165 to prevent the advancement of a pipe off of conveyor 135 and onto downstream ramp 165. When backstop tabs 145 are in the pipe blocking position, a pipe advancing off of upstream ramp 105 and onto conveyor 135 may contact backstop tabs 145 and come to rest on conveyor 135. As illustrated in FIG. 3, when in the open position, backstop tabs 145 may be in a lower position below the surface of downstream ramp 165 to allow the advancement of a pipe off of conveyor 135 and onto downstream ramp 165.

Backstop tabs 145 may be movable between the pipe blocking position and open position by a plurality of backstop tab actuators 150. Each backstop tab 145 may have an associated backstop tab actuator 150. In some embodiments, backstop tab actuators 150 may be hydraulic or pneumatic pistons. Backstop tab actuators 150 are controlled by a controller (not illustrated). The controller may control each backstop tab actuator 150 independently or as a single row collectively. The controller may be user-operated or automated. For example, an automated controller may control backstop tab actuators 150 at regular time intervals. As another example, an automated controller may control backstop tab actuators 150 when a sensor senses that a pipe has returned on conveyor 135 and is ready to be transferred from conveyor 135 to downstream ramp 165. For example, a light, motion, or pressure sensor may be configured to determine when a pipe has returned on conveyor 135 and is in alignment with downstream ramp 165. In one embodiment, a laser is used to determine when a pipe returning from processing on conveyor 135 reaches alignment with upstream ramp 105 and downstream ramp 165. When the sensor determines that a pipe has returned on conveyor 135 and is in alignment with upstream ramp 105 and downstream ramp 165, the controller may actuate backstop tab actuators 150, allowing a pipe to advance off of conveyor 135 and onto downstream ramp 165.

Downstream ramp 165 may also include pipe unloading bumpers 170 located at the bottom end of downstream ramp 165. A pipe advancing down downstream ramp 165 may contact pipe unloading bumpers 170 and come to rest at the bottom end of downstream ramp 165. Pipe unloading bumpers 170 may also prevent pipes from falling off of downstream ramp 165. Downstream ramp 165 may also include a pipe unloading location 175 located at the bottom end of downstream ramp 165. A pipe may advance down downstream ramp 165 and come to rest at pipe unloading location 175. Pipe unloading location 175 may collect one or more pipes at a time. In some embodiments, 3-5 pipes can collect at pipe unloading location 175. It should be understood that the number of pipes that may collect in pipe unloading location may vary depending on the diameter of the pipes. In some embodiments, a user may manually or mechanically unload a pipe from pipe unloading location 175. In other embodiments, a pipe may be automatically unloaded from pipe unloading location 175 to another sub-system in a pipe preparation or processing system.

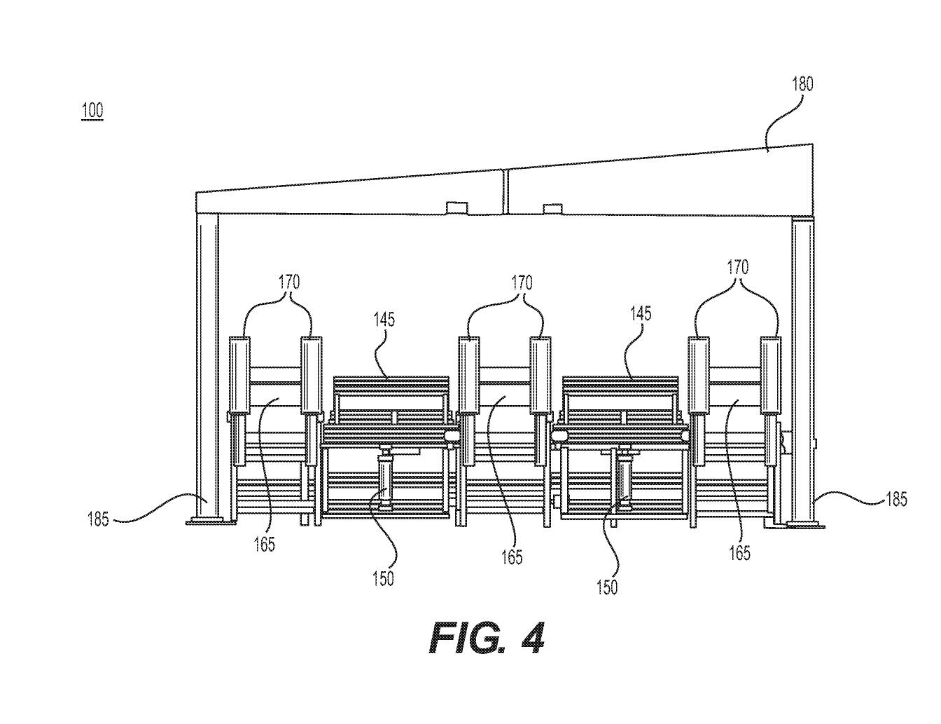

FIG. 4 illustrates a front elevation view of pipe loading and unloading station 100. Pipe loading and unloading station 100 may also include one or more canopies 180 positioned above upstream ramp 105, conveyor 135, or downstream ramp 165. Canopies 180 may be supported by canopy legs 185. Canopies 180 may serve a number of preparation or treatment functions. In some embodiments, canopies 180 may heat or cool pipes or maintain pipes at their preferred temperature. Canopies 180 may have doors or curtains to enclose the pipe loading and unloading station 100 to maintain the preferred temperature. In other embodiments, canopies 180 may provide support for mechanisms that apply a preparation, treatment, or finishing coating to pipes. In still other embodiments, canopies 180 may provide support for mechanisms that wash pipes with sprayers. For example, pressurized water nozzles may be mounted in one or more of canopies 180 above upstream ramp 105, allowing a pipe to be washed as it moves downstream towards conveyor 135. In still other embodiments, canopies 180 may provide support for mechanisms that dry pipes with heat or blowers. For example, blowers may be mounted in one or more of canopies 180 above conveyor 135, allowing a pipe to be dried as it is conveyed for processing.

Pipe loading and unloading station 100 may be used as part of a system for loading and unloading pipes. The system may include an upstream ramp 105 with a pipe loading location 115 configured to receive a pipe. As explained above, upstream ramp 105 may be slanted at a downward angle to promote the advancement of pipes in a downstream direction. The system may also include a plurality of pipe separator tabs 125 on upstream ramp 105. Pipe separator tabs 125 may be configured to actuate between an open position and pipe blocking position. The position of pipe separator tabs 125 control the advancement of a pipe down upstream ramp 105 by either blocking the pipe or allowing the pipe to advance. In some embodiments, pipe separator tabs 125 may be sequentially actuated to allow a pipe to advance from one row of pipe separator tabs 125 to the next. In some embodiments, the system may handle multiple pipes at a time. In some embodiments, a second pipe may follow a first pipe through the system. For example, pipe separator tabs 125 may control the advancement of each pipe down upstream ramp 105 so that there is a row of pipe separator tabs 125 between each pipe on upstream ramp 105.

The system may also include a conveyor 135 located at the bottom end of upstream ramp 105 configured to receive a pipe. In some embodiments, the system may also include a plurality of backstop tabs 145 configured to actuate between an open position and a pipe blocking position. As explained above, backstop tabs 145, when in a closed position, may prevent a pipe from advancing past conveyor 135 and onto downstream ramp 165. The system may also include a plurality of ejectors 155 configured to actuate between an open position and a pipe ejecting position. Ejectors 155 may eject a pipe from conveyor 135 and cause the pipe to advance down downstream ramp 165. The system may further include a pipe unloading bumper 170 configured to stop pipes at the bottom end of downstream ramp 165.

Pipe loading and unloading station may handle pipes made from a variety of materials, including steel, aluminum, concrete, or plastic. Pipe loading and unloading station 100 may handle pipes of a variety of lengths and diameters. In some embodiments, pipe loading and unloading station may handle pipes with 60 inch diameters. It should be appreciated, however, that the dimensions of the components of pipe loading and unloading station may vary based on the size of the pipe that it is intended to handle.

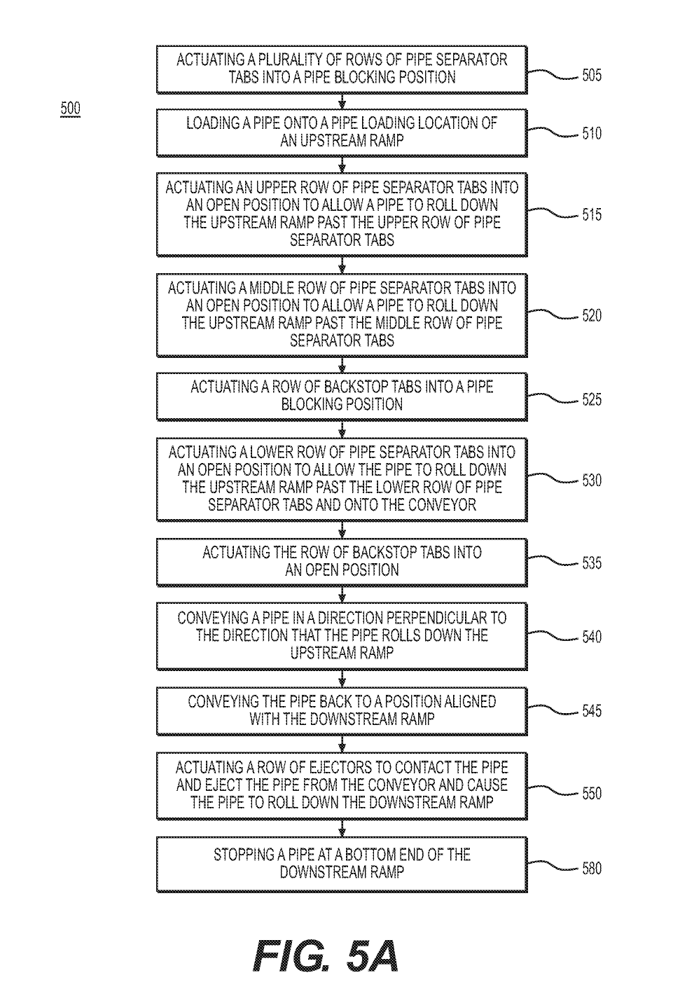

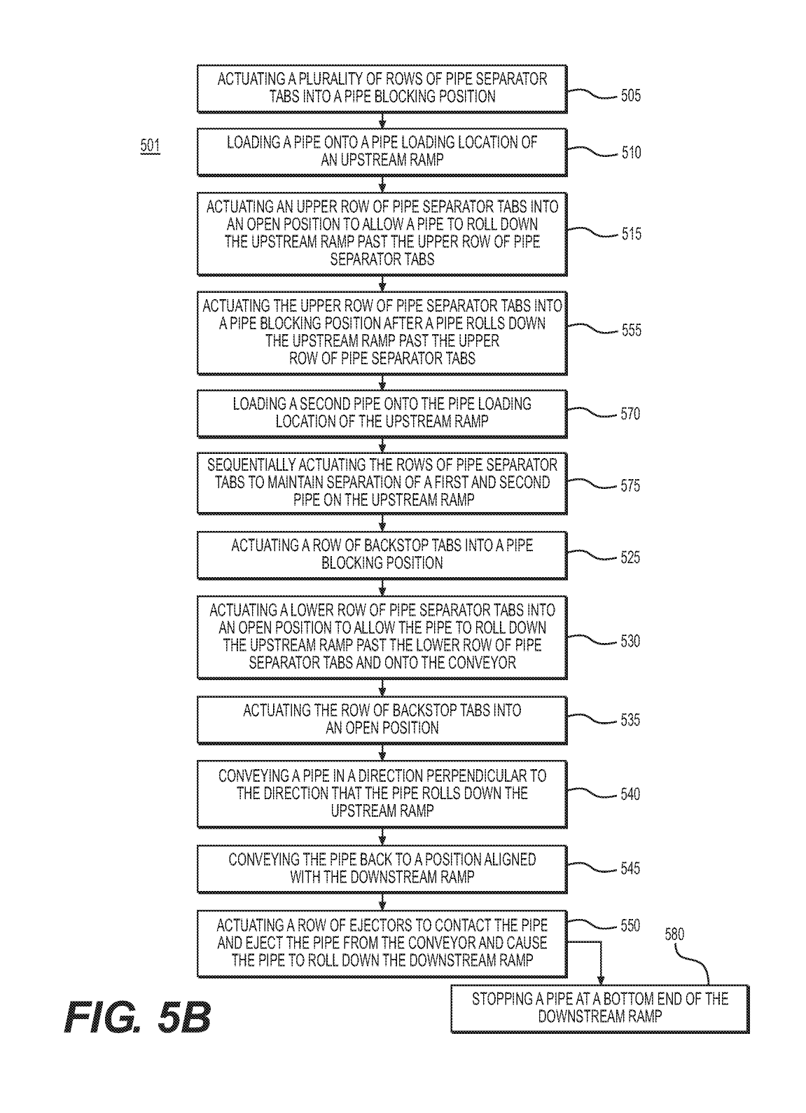

FIG. 5A is a flow chart illustrating an embodiment of a method 500 that may be utilized for loading and unloading a pipe for pipe preparation and processing applications. Method 500 may be performed by pipe loading and unloading station 100 and the system for loading and unloading pipes described herein.

As illustrated in the embodiment shown in FIG. 5A, method 500 begins with actuating a plurality of rows of pipe separator tabs 125 into a pipe blocking position (block 505). Pipe separator tabs 125 may be movable between a pipe blocking position and an open position. When in the pipe blocking position, pipe separator tabs 125 may extend above the surface of upstream ramp 105 and prevent a pipe from advancing down upstream ramp 105 past pipe separator tabs 125.

Method 500 may further include loading a pipe onto a pipe loading location 115 of upstream ramp 105 (block 510). In some embodiments, a user may manually or mechanically load a pipe onto pipe loading location 115. In other embodiments, a pipe may be automatically loaded onto pipe loading location 115 from another sub-system in a pipe preparation or processing system. Because of the downward slant of upstream ramp 105, a pipe may roll down upstream ramp 105. A pipe may roll down upstream ramp 105 until the pipe comes into contact with and comes to rest against an upper row of pipe separator tabs 125, which are in a pipe blocking position. The upper row of pipe separator tabs 125 in a blocking position may prevent the advancement of a pipe along upstream ramp 105.

Method 500 may then include actuating an upper row of pipe separator tabs 125 into an open position to allow a pipe to roll down upstream ramp 105 past the upper row of pipe separator tabs 125 (block 515). When in the open position, the upper row of pipe separator tabs 125 may be below the surface of upstream ramp 105 and allow the advancement of a pipe along upstream ramp 105. A pipe may roll down upstream ramp 105 until the pipe comes into contact with and comes to rest against a middle row of pipe separator tabs 125, which are in a pipe blocking position. The middle row of pipe separator tabs 125 in a blocking position may prevent the advancement of a pipe further along upstream ramp 105.

Method 500 may then include actuating a middle row of pipe separator tabs 125 into an open position to allow a pipe to roll down upstream ramp 105 past the middle row of pipe separator tabs 125 (block 520). When in the open position, the middle row of pipe separator tabs 125 may be below the surface of upstream ramp 105 and allow the advancement of a pipe along upstream ramp 105. A pipe may roll down upstream ramp 105 until the pipe comes into contact with and comes to rest against a lower row of pipe separator tabs 125, which are in a pipe blocking position. The lower row of pipe separator tabs 125 in a blocking position may prevent the advancement of a pipe further along upstream ramp 105.

Method 500 may next include actuating a row of backstop tabs 145 into a pipe blocking position (block 525). Backstop tabs 145 may be movable between a pipe blocking position and an open position. When in the pipe blocking position, backstop tabs 145 may extend above the surface of downstream ramp 165. In this position, backstop tabs 145 may prevent a pipe from traveling past conveyor 135.

Method 500 may next include actuating a lower row of pipe separator tabs 125 into an open position to allow a pipe to roll down upstream ramp 105 past the lower row of pipe separator tabs 125 and onto a conveyor 135 (block 530). When in the open position, the lower row of pipe separator tabs 125 may be below the surface of upstream ramp 105 and allow the advancement of a pipe along upstream ramp 105. A pipe may roll from the bottom end of upstream ramp 105 onto conveyor 135. When a pipe rolls onto conveyor 135, the pipe may come into contact with backstop tabs 145 and come to rest on conveyor 135. In some embodiments, conveyor 135 has a concave surface 140 that contours a pipe.

Method 500 may further include actuating the row of backstop tabs into an open position (block 535). When in the open position, backstop tabs 145 may be positioned below the surface of downstream ramp 165 to allow the advancement of a pipe off of conveyor 135 and onto downstream ramp 165.

Method 500 may further include conveying a pipe in a direction perpendicular to the direction that the pipe rolls down upstream ramp 105 (block 540). In some embodiments, conveyor 135 may convey a pipe to another location for processing. As examples, a pipe may be conveyed to another location to be pretreated, heated, cooled, scuffed, stripped, painted, or dried. In some embodiments, conveyor 135 may convey a pipe perpendicularly away from upstream ramp 105 and downstream ramp 165 and convey a different pipe back into alignment with upstream ramp 105 and downstream ramp 165. In other embodiments, as illustrated in FIG. 5A, conveyor 135 may convey a pipe back to a position aligned with downstream ramp 165 (block 545).

In some embodiments, actuating the row of backstop tabs into an open position (block 535) could occur after conveying a pipe perpendicular to the direction that the pipe rolls down upstream ramp 105 (block 540) or after conveying a pipe back to a position aligned with downstream ramp 165 (block 545). In these variations, the backstop tabs would remain in the pipe blocking position to prevent the pipe from prematurely rolling off of conveyor 135 and onto downstream ramp 165.

Method 500 may then include actuating a row of ejectors 155 to contact a pipe and eject the pipe from conveyor 135 and cause the pipe to roll down downstream ramp 165 (block 550). When ejectors 155 are moved into an ejecting position, the ejectors 155 may contact a pipe and cause the pipe to roll off of conveyor 135 and onto downstream ramp 165. A pipe may roll down downstream ramp 165.

Method 500 may also include stopping a pipe at the bottom end of downstream ramp 165 (block 580). Pipe unloading bumpers 170 may be located at the bottom end of downstream ramp 165. A pipe advancing down downstream ramp 165 may contact pipe unloading bumpers 170 and come to rest at the bottom end of downstream ramp 165.

FIG. 5B is a flow chart illustrating an embodiment of a method 501 that may be utilized for loading and unloading a plurality of pipes for pipe preparation and processing applications. Method 501 may be performed by pipe loading and unloading station 100 and the system for loading and unloading pipes described herein.

As illustrated in the embodiment shown in FIG. 5B, method 501 begins with actuating a plurality of rows of pipe separator tabs 125 into a pipe blocking position (block 505). Pipe separator tabs 125 may be movable between a pipe blocking position and an open position. When in the pipe blocking position, pipe separator tabs 125 may extend above the surface of upstream ramp 105 and prevent a pipe from advancing down upstream ramp 105 past pipe separator tabs 125.

Method 501 may further include loading a pipe onto a pipe loading location 115 of upstream ramp 105 (block 510). In some embodiments, a user may manually or mechanically load a pipe onto pipe loading location 115. In other embodiments, a pipe may be automatically loaded onto pipe loading location 115 from another sub-system in a pipe preparation or processing system. Because of the downward slant of upstream ramp 105, a pipe may roll down upstream ramp 105. A pipe may roll down upstream ramp 105 until the pipe comes into contact with and comes to rest against an upper row of pipe separator tabs 125, which are in a pipe blocking position. The upper row of pipe separator tabs 125 in a blocking position may prevent the advancement of a pipe along upstream ramp 105.

Method 501 may then include actuating an upper row of pipe separator tabs 125 into an open position to allow a pipe to roll down upstream ramp 105 past the upper row of pipe separator tabs 125 (block 515). When in the open position, the upper row of pipe separator tabs 125 may be below the surface of upstream ramp 105 and allow the advancement of a pipe along upstream ramp 105. A pipe may roll down upstream ramp 105 until the pipe comes into contact with and comes to rest against a middle row of pipe separator tabs 125, which are in a pipe blocking position. The middle row of pipe separator tabs 125 in a blocking position may prevent the advancement of a pipe further along upstream ramp 105.

Method 501 may then include actuating the upper row of pipe separator tabs 125 into a pipe blocking position after a pipe rolls down upstream ramp 105 past the upper row of pipe separator tabs 125 (block 555). In other words, when a pipe clears the upper row of pipe separator tabs 125, the upper row of pipe separator tabs 125 may immediately return to a pipe blocking position.

Method 501 may also include loading a second pipe onto the pipe loading location of upstream ramp 105 (block 570). The second pipe may roll down upstream ramp 105 until the second pipe makes contact with the upper row of pipe separator tabs 125. Method 501 may further include sequentially actuating the rows of pipe separator tabs 125 to maintain separation of the first and second pipe on upstream ramp 105 (block 575). For example, pipe separator tabs 125 may actuate sequentially to allow the first pipe to advance to the middle row of pipe separator tabs 125 before the second pipe is loaded onto upstream ramp 105. Then, the middle row of pipe separator tabs 125 may be actuated to an open position, allowing the first pipe to pass, and then may be actuated to a pipe blocking position. Then, the upper row of pipe separator tabs 125 may be actuated to an open position, allowing the second pipe to pass, and then may be actuated to a pipe blocking position. The rows of pipe separator tabs 125 may follow this sequence for any number of pipes moving through the system. This sequential actuating of the three rows of pipe separator tabs 125 keeps pipes separated as they advance down upstream ramp 105.

Method 501 may next include actuating a row of backstop tabs 145 into a pipe blocking position (block 525). Backstop tabs 145 may be movable between a pipe blocking position and an open position. When in the pipe blocking position, backstop tabs 145 may extend above the surface of downstream ramp 165. In this position, backstop tabs 145 may prevent a pipe from traveling past conveyor 135.

Method 501 may next include actuating a lower row of pipe separator tabs 125 into an open position to allow a pipe to roll down upstream ramp 105 past the lower row of pipe separator tabs 125 and onto a conveyor 135 (block 530).

Method 501 may further include actuating the row of backstop tabs into an open position (block 535). When in the open position, backstop tabs 145 may be positioned below the surface of downstream ramp 165 to allow the advancement of a pipe off of conveyor 135 and onto downstream ramp 165.

Method 501 may further include conveying a pipe in a direction perpendicular to the direction that the pipe rolls down upstream ramp 105 (block 540). In some embodiments, conveyor 135 may convey a pipe to another location for processing. As examples, a pipe may be conveyed to another location to be pretreated, heated, cooled, scuffed, stripped, painted, or dried. In some embodiments, conveyor 135 may convey a pipe perpendicularly away from upstream ramp 105 and downstream ramp 165 and convey a different pipe back into alignment with upstream ramp 105 and downstream ramp 165. In other embodiments, as illustrated in FIG. 5B, conveyor 135 may convey a pipe back to a position aligned with downstream ramp 165 (block 545).

In some embodiments, actuating the row of backstop tabs into an open position (block 535) could occur after conveying a pipe perpendicular to the direction that the pipe rolls down upstream ramp 105 (block 540) or after conveying a pipe back to a position aligned with downstream ramp 165 (block 545). In these variations, the backstop tabs would remain in the pipe blocking position to prevent the pipe from prematurely rolling off of conveyor 135 and onto downstream ramp 165.

Method 501 may then include actuating a row of ejectors 155 to contact a pipe and eject the pipe from conveyor 135 and cause the pipe to roll down downstream ramp 165 (block 550). When ejectors 155 are moved into an ejecting position, the ejectors 155 may contact a pipe and cause the pipe to roll off of conveyor 135 and onto downstream ramp 165. A pipe may roll down downstream ramp 165.

Method 501 may also include stopping a pipe at the bottom end of downstream ramp 165 (block 580). Pipe unloading bumpers 170 may be located at the bottom end of downstream ramp 165. A pipe advancing down downstream ramp 165 may contact pipe unloading bumpers 170 and come to rest at the bottom end of downstream ramp 165.

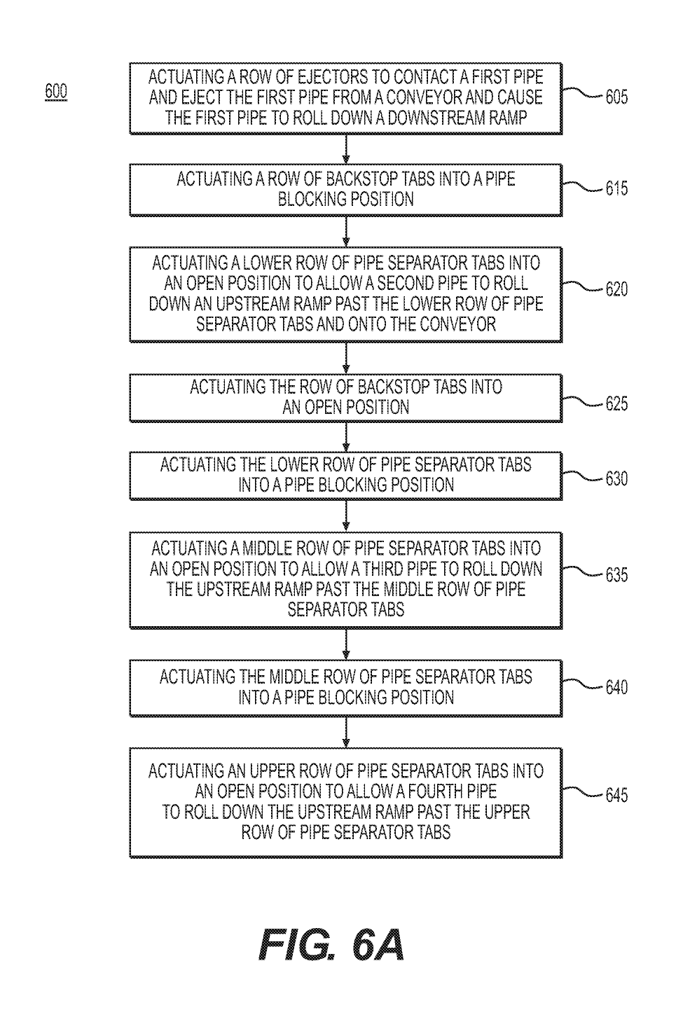

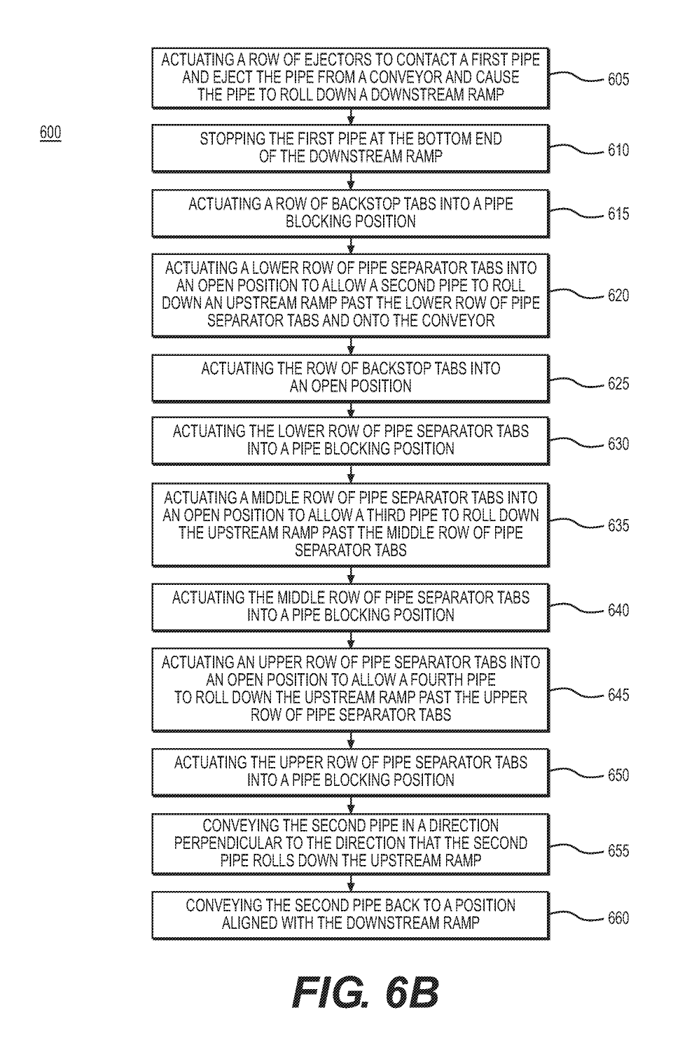

FIG. 6A is a flow chart illustrating an embodiment of a method 600 that may be utilized for loading and unloading a plurality of pipes for pipe preparation and processing applications. Method 600 may be performed by pipe loading and unloading station 100 and the system for loading and unloading pipes described herein. Method 600 is for the movement of pipes beginning with a fully loaded pipe loading and unloading station 100. Pipe loading and unloading station 100 may be fully loaded when there is a first pipe on conveyor 135 that has been conveyed back from processing, a second pipe resting against a lower row of pipe separator tabs 125 closest to conveyor 135 on upstream ramp 105, a third pipe resting against a middle row of pipe separator tabs 125 further upstream on upstream ramp 105, a fourth pipe resting against an upper row of pipe separator tabs 125 further upstream on upstream ramp 105, and no pipes on downstream ramp 165.

As illustrated in the embodiment shown in FIG. 6A, from this fully loaded position, method 600 begins with actuating a row of ejectors 155 to contact the first pipe and eject the first pipe from conveyor 135 and cause the first pipe to roll down downstream ramp 165 (block 605). When ejectors 155 are moved into an ejecting position, the ejectors 155 may contact the first pipe and cause the first pipe to roll off of conveyor 135 and onto downstream ramp 165. The first pipe may roll down downstream ramp 165.

Method 600 may also include stopping the first pipe at the bottom end of downstream ramp 165 (block 610, shown in FIG. 6B). Pipe unloading bumpers 170 may be located at the bottom end of downstream ramp 165. The first pipe advancing down downstream ramp 165 may contact pipe unloading bumpers 170 and come to rest at the bottom end of downstream ramp 165.

Method 600 may next include actuating a row of backstop tabs 145 into a pipe blocking position (block 615). Backstop tabs 145 may be movable between a pipe blocking position and an open position. When in the pipe blocking position, backstop tabs 145 may extend above the surface of downstream ramp 165. In this position, backstop tabs 145 may prevent the second pipe from traveling past conveyor 135.

Method 600 may next include actuating the lower row of pipe separator tabs 125 into an open position to allow the second pipe to roll down upstream ramp 105 past the lower row of pipe separator tabs 125 and onto conveyor 135 (block 620). The lower row of pipe separator tabs 125 may be movable between a pipe blocking position and an open position.

Method 600 may further include actuating the row of backstop tabs 145 into an open position (block 625). When in the open position, backstop tabs 145 may be positioned below the surface of downstream ramp 165 to allow the advancement of the second pipe off of conveyor 135 and onto downstream ramp 165.

Method 600 may further include actuating the lower row of pipe separator tabs 125 into a pipe blocking position (block 630). When in the pipe blocking position, the lower row of pipe separator tabs 125 may extend above the surface of upstream ramp 105 and prevent a pipe from advancing down upstream ramp 105 past pipe separator tabs 125.

These steps result in the first pipe being positioned at pipe unloading location 175, the second pipe being positioned on conveyor 135, the third pipe resting against the middle row of pipe separator tabs 125, and the fourth pipe resting against the upper row of pipe separator tabs 125.

Method 600 may then include actuating the middle row of pipe separator tabs 125 into an open position to allow the third pipe to roll down upstream ramp 105 past the middle row of pipe separator tabs 125 (block 635). When in the open position, the middle row of pipe separator tabs 125 may be below the surface of upstream ramp 105 and allow the advancement of the third pipe along upstream ramp 105. The third pipe may roll down upstream ramp 105 until the pipe comes into contact with and comes to rest against the lower row of pipe separator tabs 125, which are in a pipe blocking position. The lower row of pipe separator tabs 125 in a blocking position may prevent the advancement of the third pipe further along upstream ramp 105.

Method 600 may further include actuating the middle row of pipe separator tabs 125 into a pipe blocking position (block 640). When in the pipe blocking position, the middle row of pipe separator tabs 125 may extend above the surface of upstream ramp 105 and prevent a pipe from advancing down upstream ramp 105 past the middle row of pipe separator tabs 125.

These steps result in the first pipe being positioned at pipe unloading location 175, the second pipe being positioned on conveyor 135, the third pipe resting against the lower row of pipe separator tabs 125, and the fourth pipe resting against the upper row of pipe separator tabs 125.

Method 600 may then include actuating the upper row of pipe separator tabs 125 into an open position to allow the fourth pipe to roll down upstream ramp 105 past the upper row of pipe separator tabs 125 (block 645). When in the open position, the upper row of pipe separator tabs 125 may be below the surface of upstream ramp 105 and allow the advancement of the fourth pipe along upstream ramp 105. The fourth pipe may roll down upstream ramp 105 until the fourth pipe comes into contact with and comes to rest against the middle row of pipe separator tabs 125, which are in a pipe blocking position. The middle row of pipe separator tabs 125 in a blocking position may prevent the advancement of the fourth pipe further along upstream ramp 105.

Method 600 may further include actuating the upper row of pipe separator tabs 125 into a pipe blocking position (block 650, shown in FIG. 6B). When in the pipe blocking position, the upper row of pipe separator tabs 125 may extend above the surface of upstream ramp 105.

These steps result in the first pipe being positioned at pipe unloading location 175, the second pipe being positioned on conveyor 135, the third pipe resting against the lower row of pipe separator tabs 125, and the fourth pipe resting against the middle row of pipe separator tabs 125.

Method 600 may further include conveying the second pipe in a direction perpendicular to the direction that the second pipe rolls down upstream ramp 105 (block 655, shown in FIG. 6B). In some embodiments, conveyor 135 may convey a pipe to another location for processing. As examples, a pipe may be conveyed to another location to be pretreated, heated, cooled, scuffed, stripped, painted, or dried. In some embodiments, conveyor 135 may convey the second pipe perpendicularly away from upstream ramp 105 and downstream ramp 165 and convey a different pipe back into alignment with upstream ramp 105 and downstream ramp 165. In other embodiments, method 600 may include conveying the second pipe back to a position aligned with downstream ramp 165 (block 660, shown in FIG. 6B).

The invention of the disclosure may enjoy numerous advantages. First, separating each pipe with sequentially controlled pipe separator tabs 125 has the advantage of preventing multiple pipes from rolling together down upstream ramp 105. Having each pipe roll independently helps avoid the problems caused by the weight of multiple pipes piling up against pipe separator tabs 125. If the weight of multiple pipes rest against pipe separator tabs 125, pipe separator tabs 125 can break or be forced into an open position. Separating each pipe with pipe separator tabs 125 may have the additional advantage of preventing collisions between pipes on upstream ramp 105. Colliding pipes may cause damage to one another and may cause chipping, smearing, or transfer of the coating or treatment applied by canopies 180.

Second, the invention allows pipes to advance down upstream ramp 105 at a controlled speed. Pipe separator tabs 125 can be controlled to actuate at set time intervals to ensure that a pipe is on upstream ramp 105 for a predetermined amount of time. This has the advantage of allowing canopies 180 to provide a consistent amount of heating, cooling, coating, spraying, or drying.

Third, conveyor 135 may convey a pipe in a direction perpendicular to upstream ramp 105 and downstream ramp 165 to another location for further processing. Conveyor 135 may be configured to convey a pipe away from upstream ramp 105 and downstream ramp 165 to a processing location and convey the same pipe back into alignment with upstream ramp 105 and downstream ramp 165. Accordingly, pipes can be transported and treated with fewer transfers. This has the advantage of reducing production time and costs.

Finally, the invention has the additional advantage of loading, transferring, and unloading pipes in a safe, controlled, and automated manner. The invention can reduce the need for manual labor, thereby reducing workplace injury and saving manufacturing costs.

The many features and advantages of the present disclosure are disclosed in the detailed specification. Thus, it is intended by the appended claims to cover all such features and advantages of the present disclosure which fall within the true spirit and scope of the present disclosure. Further, since numerous modifications and variations will readily occur to those skilled in the art, it is not desired to limit the present disclosure to the exact construction and operation illustrated and described, and accordingly, all suitable modifications and equivalents may be resorted to, falling within the scope of the present disclosure.

What is claimed is:

1. A pipe loading and unloading station comprising:
an upstream ramp including a plurality of movable pipe separator tabs;
a downstream ramp including a plurality of movable backstop tabs; and
a conveyor located between the upstream ramp and downstream ramp, the conveyor including a plurality of movable ejectors.

2. The pipe loading and unloading station of claim 1, wherein the plurality of movable pipe separator tabs are arranged in a plurality of rows along the upstream ramp, the plurality of movable ejectors are arranged in a single row positioned between the upstream ramp and conveyor, and the plurality of movable backstop tabs are arranged in a single row positioned between the conveyor and downstream ramp.

3. The pipe loading and unloading station of claim 2, further comprising a plurality of pipe separator tab actuators configured to actuate the pipe separator tabs between an open position and a pipe blocking position, a plurality of ejector actuators configured to actuate the ejectors between an open position and a pipe ejecting position, and a plurality of backstop tab actuators configured to actuate the backstop tabs between an open position and a pipe blocking position.

4. The pipe loading and unloading station of claim 3, wherein the pipe separator tab actuators, the ejector actuators, and the backstop tab actuators are hydraulic or pneumatic pistons.

5. The pipe loading and unloading station of claim 1, wherein the conveyor has a concave surface.

6. The pipe loading and unloading station of claim 5, wherein the conveyor includes a conveyor belt.

7. The pipe loading and unloading station of claim 1, wherein the conveyor is configured to convey a pipe in a direction perpendicular to the upstream ramp and the downstream ramp.

8. The pipe loading and unloading station of claim 1, further comprising one or more canopies located above the upstream ramp and conveyor.

9. A system for loading and unloading pipes, comprising:
an upstream ramp including a pipe loading location configured to receive a first pipe;
a plurality of pipe separator tabs on the upstream ramp configured to actuate between an open position and a pipe blocking position to control the advancement of the first pipe down the upstream ramp;
a conveyor located at the bottom end of the upstream ramp configured to receive the first pipe;
a plurality of backstop tabs configured to actuate between an open position and a pipe blocking position and control the advancement of the first pipe past the conveyor and to a downstream ramp;
a plurality of ejectors configured to actuate between an open position and a pipe ejecting position and eject the first pipe from the conveyor and cause the first pipe to advance down the downstream ramp; and
a pipe unloading bumper configured to stop the first pipe at the bottom end of the downstream ramp.

10. The system for loading and unloading pipes of claim 9, wherein the conveyor is configured to convey a pipe in a direction perpendicular to the upstream ramp and the downstream ramp.

11. The system for loading and unloading pipes of claim 9, wherein hydraulic or pneumatic pistons are configured to actuate the pipe separator tabs between the open position and the pipe blocking position, hydraulic or pneumatic pistons are configured to actuate the ejectors between the open position and the pipe ejecting position, and hydraulic or pneumatic pistons are configured to actuate the backstop tabs between the open position and the pipe blocking position.

12. The system for loading and unloading pipes of claim 9, wherein the pipe separator tabs are sequentially actuated.

13. The system for loading and unloading pipes of claim 12, wherein a second pipe follows the first pipe through the system.

14. A method of loading and unloading pipes, comprising:
actuating a plurality of rows of pipe separator tabs into a pipe blocking position;
loading a pipe onto a pipe loading location of an upstream ramp;
actuating an upper row of pipe separator tabs into an open position to allow the pipe to roll down the upstream ramp past the upper row of pipe separator tabs;
actuating a middle row of pipe separator tabs into an open position to allow the pipe to roll down the upstream ramp past the middle row of pipe separator tabs;
actuating a row of backstop tabs into a pipe blocking position;
actuating a lower row of pipe separator tabs into an open position to allow the pipe to roll down the upstream ramp past the lower row of pipe separator tabs and onto the conveyor;
actuating the row of backstop tabs into an open position;
conveying the pipe in a direction perpendicular to the direction that the pipe rolls down the upstream ramp;
conveying the pipe back to a position aligned with the downstream ramp; and
actuating a row of ejectors to contact the pipe and eject the pipe from the conveyor and cause the pipe to roll down the downstream ramp.

15. The method of claim 14, further comprising actuating the upper row of pipe separator tabs into a pipe blocking position after the pipe rolls down the upstream ramp past the upper row of pipe separator tabs.

16. The method of claim 15, further comprising actuating the middle row of pipe separator tabs into a pipe blocking position after the pipe rolls down the upstream ramp past the middle row of pipe separator tabs.

17. The method of claim 16, further comprising actuating the lower row of pipe separator tabs into a pipe blocking position after the pipe rolls down the upstream ramp past the lower row of pipe separator tabs.

18. The method of claim 17, further comprising loading a second pipe onto the pipe loading location of the upstream ramp.

19. The method of claim 18, further comprising sequentially actuating the rows of pipe separator tabs to maintain separation of the first and second pipe on the upstream ramp.

20. A method of loading and unloading pipes, comprising:
actuating a row of ejectors to contact and eject a first pipe from a conveyor, causing the first pipe to roll down a downstream ramp;
actuating a row of backstop tabs into a pipe blocking position;
actuating a lower row of pipe separator tabs into an open position to allow a second pipe to roll down an upstream ramp past the lower row of pipe separator tabs and onto the conveyor;
actuating the row of backstop tabs into an open position;
actuating the lower row of pipe separator tabs into a pipe blocking position;
actuating a middle row of pipe separator tabs into an open position to allow a third pipe to roll down the upstream ramp past the middle row of pipe separator tabs;
actuating the middle row of pipe separator tabs into a pipe blocking position; and
actuating an upper row of pipe separator tabs into an open position to allow a fourth pipe to roll down the upstream ramp.
